(19) United States
(12) Patent Application Publication
(10) Pub. No.: US 2013/0268416 A1
(43) Pub. Date: Oct. 10, 2013

(54) SAMPLE IDENTIFICATION AND DISTRIBUTION SYSTEM

(71) Applicant: Adam I. SANDOW, Boca Raton, FL (US)

(72) Inventor: Adam I. SANDOW, Boca Raton, FL (US)

(21) Appl. No.: 13/439,517

(22) Filed: Apr. 4, 2012

(51) Int. Cl. G06Q 10/08; G06Q 50/28

(52) U.S. Cl. 705/28; 705/330

(57) ABSTRACT

A system and method for identification and distribution of sample material include maintaining a database including information on a plurality of materials and an associated inventory of sample materials; identifying a subset of materials based on selected search criteria; displaying at least part of the information defining the subset of materials; receiving a selection of desired materials from the subset; queuing from the database and executing a distribution order by which sample materials for the desired materials are provided to a recipient.

### FIELD OF THE DISCLOSURE

The present disclosure relates generally to the field of materials consulting, including in architecture, interior design, industrial design and fashion, and in particular to a system for identification and distribution of materials samples to designers.

### BACKGROUND

Various methods are known to be useful for review and selection of materials for an interior design project. Traditionally, designers have access to catalogs and also sample books or similar sample collections that include sheets or color swatches or other samples of a material in order to assist the designer in selecting a material. Based on this review, a designer can then order the material for his or her project. Of course, the utility of the sample books is limited by their size, weight and overall bulkiness, particularly if they contain a large number of samples of sufficient size to be useful. Furthermore, sample books can be expensive. While conventional sample books and other forms such as sample files, flip cards, etc. in the prior art are useful in some instances, they also have deficiencies and the potential remains open for more useful and efficient methods and systems for the review and selection of materials, and particularly in the area of materials sampling.

### SUMMARY OF THE INVENTION

A method and system for identification and distribution of material samples is described. The method can include maintaining a computerized database containing information defining a plurality of materials available for one of distribution and sale, and maintaining an associated inventory of sample materials representing at least some of the plurality of materials. The step of managing the database can include accessing at least one supplier database storing information on at least one of the plurality of materials and retrieving information on at least one of the description, the image, or classifying data for the at least one material.

The information defining the plurality of materials can include a description, an image, and a plurality of classifying data providing information associated with each material. The method can also include identifying a subset of the plurality of materials based on selected search criteria provided by a user; displaying at least part of the information associated with the subset of the plurality of materials; and receiving a selection of desired materials from the subset from the user. Once the selection is received, the method can also include queuing from the database and executing a distribution order by which the sample materials corresponding to at least part of the selection of the desired materials are provided to a recipient. The method can then include updating the database to reflect execution of the distribution order and passing out from the inventory of the sample materials provided to the recipient.

The plurality of materials can be selected from the group consisting of natural and synthetic textiles, glass, stone materials, ceramic materials, metals, laminates, lumber, paint, other coatings and combinations thereof. The plurality of classifying data comprises at least one of: application for material, type of material, color, color family, brand, price range, size, pattern, origin, sustainability, designer, and texture information for each material.

The selected search criteria can include material identifiers associated with a subset comprising at least one material. The step of identifying the subset further comprises receiving the material identifier, searching the database using the material identifier as at least one search criterion, and associating the material identifier with the subset based on at least partial matching of the material identifier with the subset. The material identifier can include a uniform resource locator; and displaying the subset can include providing a web page link associated with the uniform resource locator and including the subset of materials.

The database and the selected search criteria can both contain classifying data. For such a search, the step of identifying the subset of the plurality of materials can also include searching the database to identify a primary subset of the plurality of materials based on a primary subset of the classifying data; and searching the primary subset to identify a secondary subset of the plurality of materials based on a secondary subset of the classifying data.

The selected search criteria can include an external image. For such a search, the step of identifying the subset of the plurality of materials can include receiving the external image; identifying image characteristics associated with the external image; and searching the database to identify a subset of the plurality of materials associated with at least part of the image characteristics of the external image.

The selected search criteria can include input text. For such a search, the step of identifying the subset of the plurality of materials can also include receiving the input text; and searching the database to identify a subset of the plurality of materials with descriptions corresponding to at least part of the input text.

The step of executing the distribution order for the sample materials can include receiving recipient shipping information; and generating shipping indicia for delivery of the samples according to predetermined terms. The method can also include associating each of the plurality of materials with a supplier and invoicing a supplier based on the number of sample materials supplied by the supplier that are distributed to recipients.

The method can also include retrieving at least one sample back into the inventory of sample materials and updating the database to reflect the retrieval of the sample materials. The method can also include associating in the database a substantially unique identifier (UID) with the sample materials and further comprising tracking the inventory of sample materials via the UID. The UID can be associated with a supplier's serial number for the sample material.

These and other features, objects and advantages of the present method and system will become more apparent to one skilled in the art from the following description and claims when read in light of the accompanying drawings.

### BRIEF DESCRIPTION OF THE DRAWINGS

FIG. 1 is a high-level block diagram of an example of the method described herein.

FIG. 2 is a block diagram showing the search processes portion of the embodiment shown in FIG. 1.

FIG. 3 is a stylized overview of an example of the system described herein connected to a plurality of interconnected computing devices.

FIG. 4 is a high-level block diagram of an example of the system described herein.

FIG. 5 is a flow diagram of an example of the system described.

FIG. 6 is a schematic of an electronic publication associated with the system described herein.

FIG. 7 is a flow diagram of another example of the system described herein.

### DETAILED DESCRIPTION

Interior design, industrial design, architecture and fashion can involve the combination and coordination of multiple materials of various characters, texture, color, etc., in various applications to create an effective, and preferably aesthetically pleasing, whole. Some features of materials may not be accurately depicted in photographs or in locations such as stores that have lighting different from the space where the material will ultimately be utilized. Also, photographs cannot always convey the texture and feel of a material. Therefore, in-space and/or in-person evaluation of actual materials under consideration can be an important step in the design process. Similarly, obtaining sample materials for comparison or further evaluation can provide a more efficient and less expensive approach to the ability to evaluate actual materials for an interior design application, compared, for example, with maintaining a full inventory of all available materials and options for review by prospective users.

As used herein, the terms “sample” and “sample material” refer to a limited size or quantity of a material intended to represent a larger size or quantity of the material. For example, a sample can include an easily handled piece of a material, such as a fabric swatch, or a limited quantity of a material, such as a single tile.

Although described with respect to interior design, it is to be understood that the system and methods described herein can also be used for industrial designs, architecture, fashion design, product development, and other creative enterprises.

A system and methods for identification and distribution of materials, and particularly samples, is described herein. The sampling system and methods provide the capability to efficiently search and review materials from an expansive collection, potentially including a sample representing every material and option offered by a supplier or multiple suppliers, but at least including a subset of the supplier's or multiple suppliers' offerings, and expeditiously to obtain samples of selected materials for further in-person evaluation.

One object of the sampling system and methods is to improve the overall efficiency, accuracy and effectiveness in the selection of materials for design applications, including but not limited to interior design, industrial design, architecture and fashion design. Part of the efficiency can arise from processes that include maintaining a complete database of materials at a centralized distribution location, so that sample requests can be fulfilled immediately using overnight shipping without the need to wait for samples to be provided by the vendor. In addition, conventional sample distribution methods are extremely expensive because each sample book must include all samples the manufacturer wishes to offer for distribution. Thus, additional efficiency and effectiveness gains are realized since far fewer samples are required to reach a larger potential purchasing audience because all samples can be reviewed by any user, but samples are only sent to those that are interested in purchasing a particular material. Further efficiency can be realized by implementing the system in a manner where samples can be returned by users and restocked in inventory if they are not damaged. In addition to cost savings, this is a more environmentally friendly approach than conventional sample books.

Another object is to overcome the size and weight constraints and comparative bulkiness of prior art interior design practices that typically rely on physical sample books containing many samples beyond those of interest to the designer, or having to order a full quantity or custom order of a material to accurately evaluate materials in the context of the lighting, other materials, and/or room in which the material will be used.

Another object of the sampling system and methods is to facilitate the transit of sample materials between suppliers and users, e.g., designers or consumers. Another object is to facilitate and expedite the ordering, delivery and overall management of sample materials.

In disclosed embodiments, the sampling system 200 and method 100 can include the preliminary steps of identifying a plurality of materials, locating or receiving an inventory 250 of sample materials representing each or at least some of the plurality of materials, and generating a database 230 including information related to the materials and samples. The database 230 can be computerized.

The plurality of materials advantageously includes materials available for distribution and/or sale. The plurality of materials can include materials for interior design applications, industrial design applications, architecture and/or fashion. The materials can include, without limitation, textiles, glass, stone materials, ceramic materials, metals, laminates, lumber, and other materials applied as countertop materials, floor coverings, wall coverings, window treatments, upholstery, cabinetry, furniture, fixtures, paints and other coatings.

The sample materials can be supplied by at least one supplier or a plurality of suppliers. As used herein, the term “supplier” refers to a manufacturer, distributer, retailer or other source providing a sample material, material, or product incorporating the material.

The database 230 can contain information describing the plurality of materials. The information can include a description, an image, and a plurality of classifying data associated with each material. The description can include a title or other name for the material. The description can also include a narrative describing the material.

The plurality of classifying data advantageously can include various features for the materials affecting the comparison and selection process. Classifying data can include the application for material, the type of material, color, color family, style, brand, price range, size, pattern, origin, sustainability, designer, texture of the material, supplier, designer referral, and contract for the material. As used herein, the term “color family” refers to a basic color name encompassing a grouping of similar colors. For example, a color family of white can include colors such as pure white, pearl white, cream, and vanilla. Materials can also be classified, including temporarily classified, as new collections material.

The information on the plurality of materials in the database 230 can also include contextual images for at least a portion of the plurality of materials. As used herein, the term “contextual image” refers to an image showing an application of a material, such as showing a particular textile as upholstery on a chair, or otherwise showing the use of a material in the context of a room or furnishing, etc.

The database 230 can also contain information regarding the inventory 250 of sample materials representing at least some of the plurality of materials. The information can include the number of samples in inventory for each material. The information can also identify and characterize the supplier of the sample materials and terms of sale or distribution, e.g., shipping options, guarantees and the like. The database 230 can also associate a substantially unique identifier (UID) with the sample materials. The UIDs can be selected according to an order or can be randomly generated. The UIDs can also be associated with a supplier or with a supplier's serial or other identification number for the sample material. As used herein, “at least some” includes at least one, but is also intended to include “a majority of”and “all.”

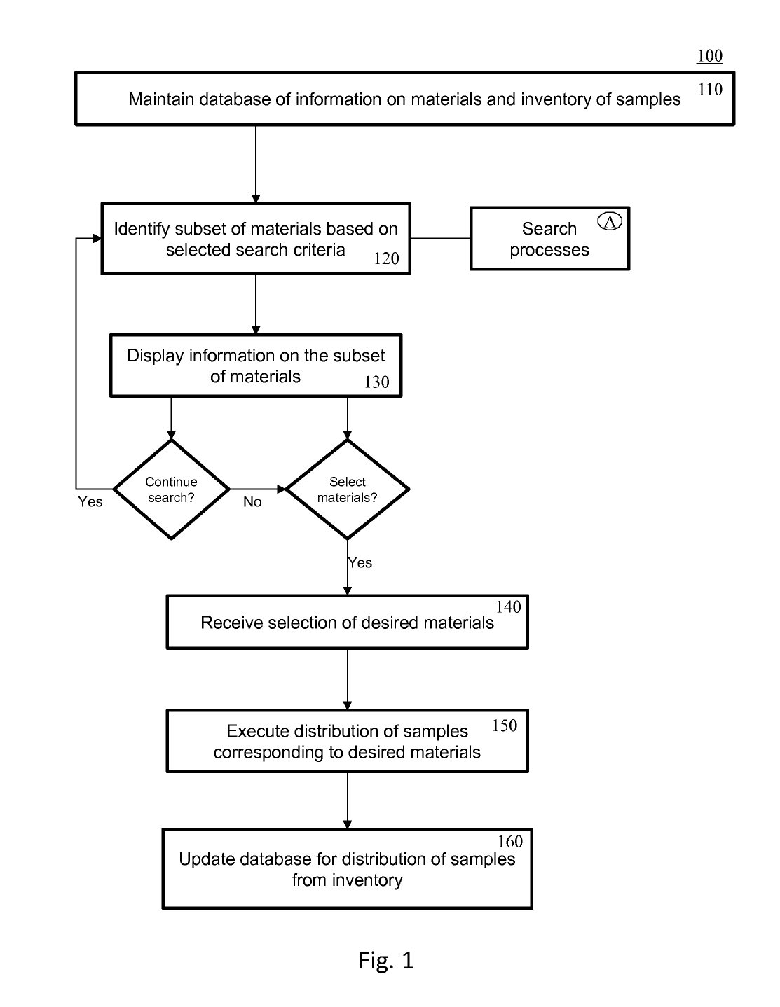

As shown in FIG. 1, the method 100 can include the steps of maintaining the database 110; identifying a subset of the plurality of materials based on selected search criteria provided by a user 120; displaying at least part of the information defining the subset of the plurality of materials 130; receiving from a user a selection of desired materials from the subset 140; and queuing from the database and executing a distribution order 150 by which the sample materials corresponding to at least part of the selection of the desired materials are provided to a recipient. The method 100 can also include updating the database 160 to reflect execution of the distribution order and distributing the sample materials from the inventory to the recipient.

Maintaining the database 110 can include generating the database, obtaining additional information for the database and/or updating existing information in the database. Maintaining the database 110 can also include accessing at least one third party database, such as a supplier database, containing information on at least one of the plurality of materials and retrieving information for the material. For example, information related to at least one of the description, the image, and at least one type of classifying data can be retrieved from the third party source for use in the database. The databases can also be associated such that an update to the third party database can prompt an update to the corresponding information in the database.

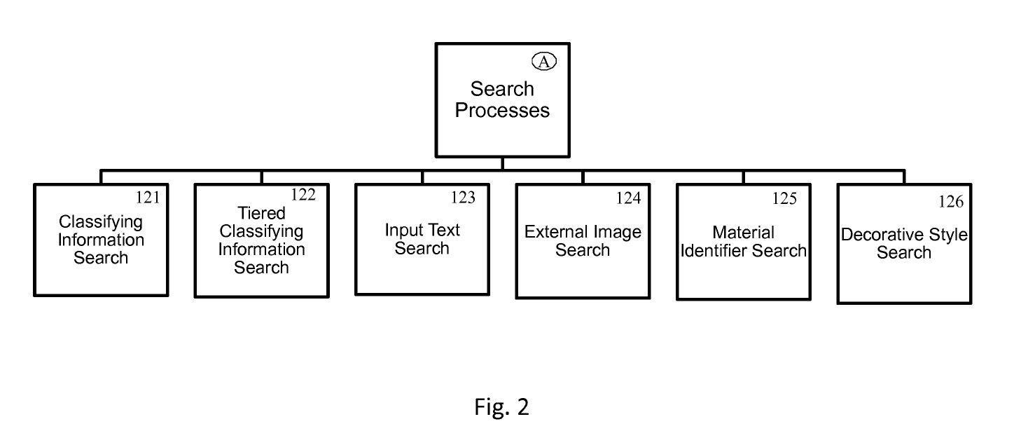

Upon initial accessing of the database, the plurality of materials can be displayed in a default order or a portion of the materials can be displayed in a default order. Various search processes (A), including those shown in FIG. 2, can be used to identify a subset of the plurality of materials based on search criteria provided by a user. Each of the various search processes (A) can be applied in the alternative or in combination, such as in succession. Each of the search processes (A) can also be revised and/or repeated according to a user's selection.

In one search process (A), the database can be searched to identify a subset of the plurality of materials based on selected classifying data 121. The selected classifying data can include one type of information or a combination of more than one type. Searching the database can also occur in tiered steps 122. For example, the database can be searched to identify a primary subset of the plurality of materials based on a primary subset of the classifying data, then the database can be searched to identify a secondary subset of the plurality of materials based on a secondary subset of the classifying data.

The primary criteria can include a selection from a limited set of the classifying data. For example, the primary criteria can include at least one of color, application, type, or brand. The secondary criteria can include a selection from the remaining classifying data that was not utilized in the primary search or all of the classifying data.

In another search process (A), the database can be searched to identify a subset of the plurality of materials based on input text from a user 123. The process can include receiving the input text, and searching the database for materials with descriptions corresponding to at least part of the input text.

In another search process (A), the database can be searched to identify a subset of the plurality of materials based on an external image 124. The external image can be provided by a user. For example, a user can photograph, copy, download, or otherwise capture an image of a material and provide this external image. The external image can be provided by uploading the image or otherwise providing access to the external image by the processor 215. The search process can include receiving the external image, identifying image characteristics associated with the external image, and searching the database to identify a subset of the plurality of materials associated with at least part of the image characteristics of the external image. Image characteristics can include, without limitation, any of color, pattern, texture, or any of the classifying data.

In another search process (A), the database can be searched to identify a subset of the plurality of materials based on one or more material identifiers 125. The material identifier can be associated with a subset including at least one material. For example, a separate material identifier can be associated with each individual material. Material identifiers can also be associated with various subsets of materials. The search process can include receiving the material identifier, searching the database using the material identifier as at least one search criterion, and associating the material identifier with the subset based on at least partial matching of the material identifier with the subset.

In one arrangement, the material identifier can include a uniform resource locator (URL) and displaying the subset 130 can also include providing a web page link associated with the uniform resource locator and including the subset of materials. A source document can include hyperlinks to at least one of the URLs for the materials.

In another search process (A), the database can be searched to identify a subset of the plurality of materials based on a selected decorative style search 126. Styles can include terms generally used in an industry including, but not limited to, interior design, industrial design, architecture and fashion. For example, interior design styles can include traditional, modern, and transitional.

At least a portion of the contextual images in the database 230 can be associated with a decorative style. The search process can include receiving the selected style and searching the database to identify a subset of the contextual images associated with the style, and displaying the subset of contextual images. The search based on decorative style can also be combined with at least one type of classifying data, such as color, color family, material, etc.

The user can browse the subset of contextual images, further narrow the search, or start a new search. While browsing the contextual images, a user can request and receive additional information on the particular materials shown in an image. For example, a contextual image can be displayed together with a listing of the materials, or the contextual image can contain links to information on the materials. In the latter option, the user can select a particular material (e.g., by clicking with mouse or tapping with touch screen) and obtain additional details regarding that material (e.g., by being redirected to the material main page).

As a result of the searches, at least part of the information defining the resulting subsets of the plurality of materials can be displayed 130. At least a portion of the subset materials can be displayed together, such as on a results page. At least part of the information for each material can also be displayed separately, such as on a material main page.

In order to assist a user in the evaluation of the materials, the method 100 can also include a side-by-side comparison feature, e.g. a chart, including displaying at least a portion of the same types of information for at least two materials. The method 100 can also include displaying a specification sheet providing additional information on a material.

The method 100 can also include displaying a computer-aided design (CAD) depiction providing additional information on a material. For example, the CAD depiction can show how the material could be incorporated into a room, furniture, clothes, etc. The CAD depiction can be available to the user for download. The method 100 can also include displaying an enlarged image, including a high resolution image, of a material.

The method 100 can also include displaying additional images of a material, including one or more contextual image. The database 230 can also associate and display contextual images from other sources, including other databases, that display a material, including an applied material.

The method 100 can also include identifying and displaying a subset of materials from the plurality of materials determined to be similar to a particular material. Similarity can be determined based on various characteristics, including without limitation color, color family, type of material, texture, and application.

The method 100 can also include receiving and executing instructions to transfer a copy of an image of a material or other information for the material via download, e-mail transmission, multimedia messaging services (MMS), or through social media technologies. The method 100 can also include receiving and executing instructions to contact another resource such as a supplier, a materials consultant, or a materials librarian including via e-mail, telephone, live chat or other messaging options.

A user can select materials from the database 230. The selected materials can be saved as a project and/or identified as desired materials. When saving a subset of materials as a project, the subset can be associated with a project identifier. A user can subsequently retrieve the saved subset using the project identifier.

A selection of desired materials can be received and queued from the database for execution of a distribution order 160 by which the sample materials corresponding to the desired materials, or at least part of the selection, are provided to a recipient. The user can be a verified design professional, a design professional, or a direct consumer. The recipient can be the user or another entity identified by the user.

The step of executing the distribution order 160 for the sample materials can also include receiving recipient shipping information and generating shipping indicia for delivery of the samples according to predetermined terms. For example, the shipping indicia can include shipping labels. In order to facilitate the design process, the shipping method can include overnight delivery. To facilitate rapid distribution, the inventors of sample materials can be maintained at a centralized distribution facility or a plurality of centralized distribution facilities (e.g., one in the US, one in Europe, one in Asia, etc.). The distribution facility can be maintained by the same entity maintaining the database or can be a separate entity that receives orders from the entity maintaining the database. Similarly, by maintaining a complete (or nearly complete) inventory of sample materials, instead of obtaining the sample materials from the manufacturer on-demand, the samples can be sent via overnight delivery and the process works seamlessly from the users perspective.

Executing distribution can also include computing the total weight of samples corresponding to the desired materials or computing the total size of the samples to determine the shipping costs and/or packaging. Executing the distribution can also include generating a return shipping label and providing the return shipping label and/or return shipping packaging in a shipment of sample materials. The method 100 can also include receiving at least one returned sample into the inventory of sample materials.

To further expedite distribution, a user can also provide registration information. Registration information can include, without limitation, name, user contact information, and recipient names and addresses. Recipient information can also include default recipient names and addresses and other recipient names and addresses. Registration information can also include payment information such as credit card numbers or bank routing and account number and payment authorization instructions. Registration information can be received and stored in the database or an associated database. Registration for a particular user or account can be identified by an account identifier, such as an alphanumeric username or an account number. However, the system and method can also be operated such that the suppliers of the materials are billed, while the users are not billed.

The processor 215 can receive information from a user indicating that the user is associated with particular registration information. Once associated, the processor 215 can initiate the distribution process based on the registration information without the need for additional input from the user. For example, options can include distributing samples for all selected materials to a default recipient or selecting all displayed materials and distributing samples for them to a recipient. Options such as these can also be selected by a user through a one-click process.

The method 100 can also include tracking the inventory of sample materials. For example, the method 100 can include updating the database to reflect execution of the distribution order and distribution of the sample materials provided to the recipient from the inventory. The method 100 can also include updating the database to reflect the receipt of any returned and/or restocked sample material(s). The inventory of sample materials can also be tracked via the UID assigned to each sample.

The method 100 can also include associating each of the plurality of materials or sample materials with a supplier and invoicing one of the supplier or the user based on the number of sample materials distributed. In one arrangement, a supplier can be charged for the number of sample materials provided by the supplier that are distributed to recipients.

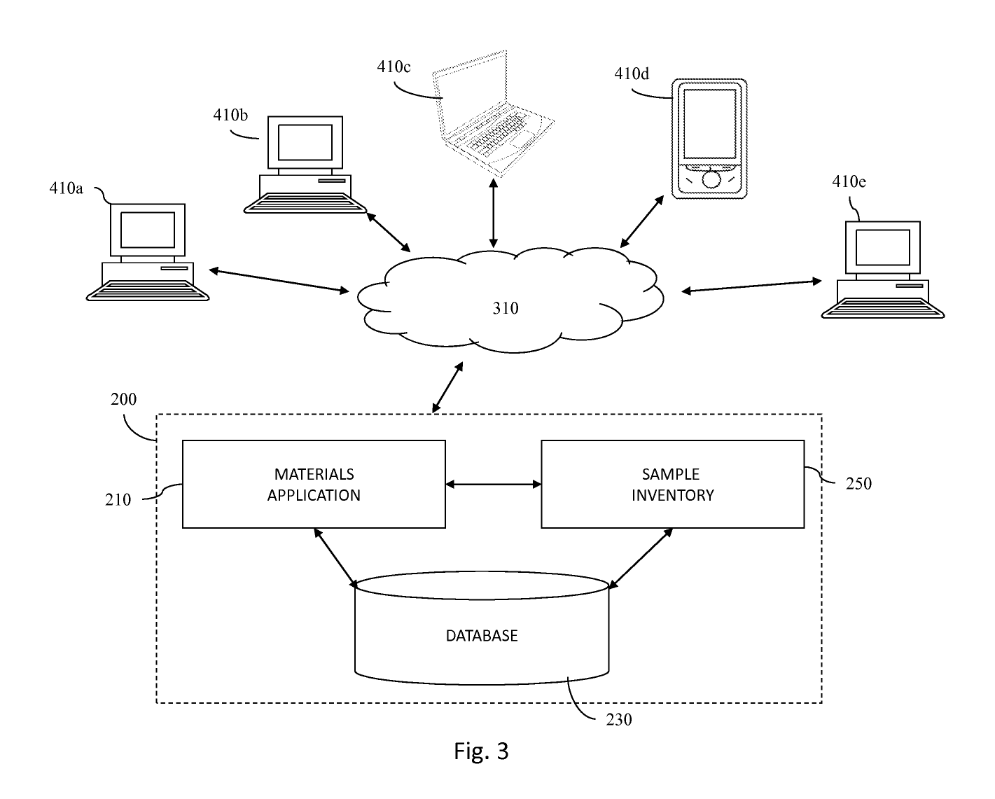

A system 200 for identification and distribution of sample materials is also described herein. The system 200 and its operation can embody some or all of the methods 100 described above and variations thereof. The methods 100 can also be implemented using a software application 210 executed by a processor 215. Processors 215 can include any central processing unit (CPU), microprocessor, micro-controller, or computational device or circuit for executing instructions and be connected to a communication infrastructure 310 (e.g., a communications bus, cross-over bar, or network). As shown in FIG. 3, the system 200 can be connected to at least one input/output (I/O) device 410. The I/O devices 410 can display graphics, text, and other data on a monitor or other screen and receive data from a user for transmission to the at least one data processor 215 of the system 200 through the communication infrastructure 310.

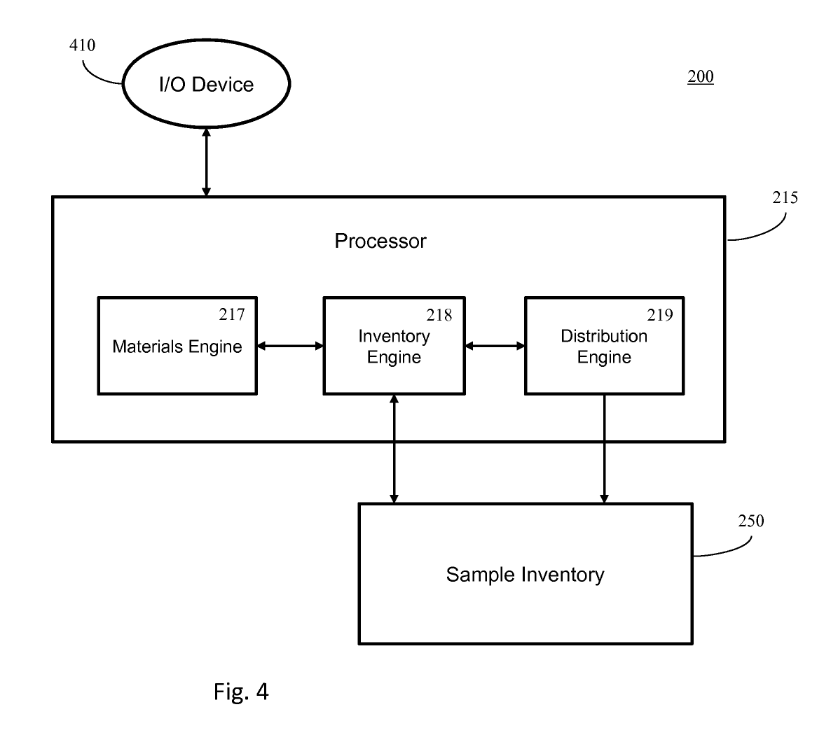

As shown in FIGS. 3 and 4, the system 200 can include at least one data processor 215 having access to a data memory configured to maintain a database 230 and being programmed to execute instructions. The at least one data processor 215 can include a processor devoted to use as a materials database engine 217. The materials database can include information describing the plurality of materials. The materials engine 217 can be programmed to execute a process for searching the materials database and displaying a subset of the plurality of materials based on selected search criteria provided by a user.

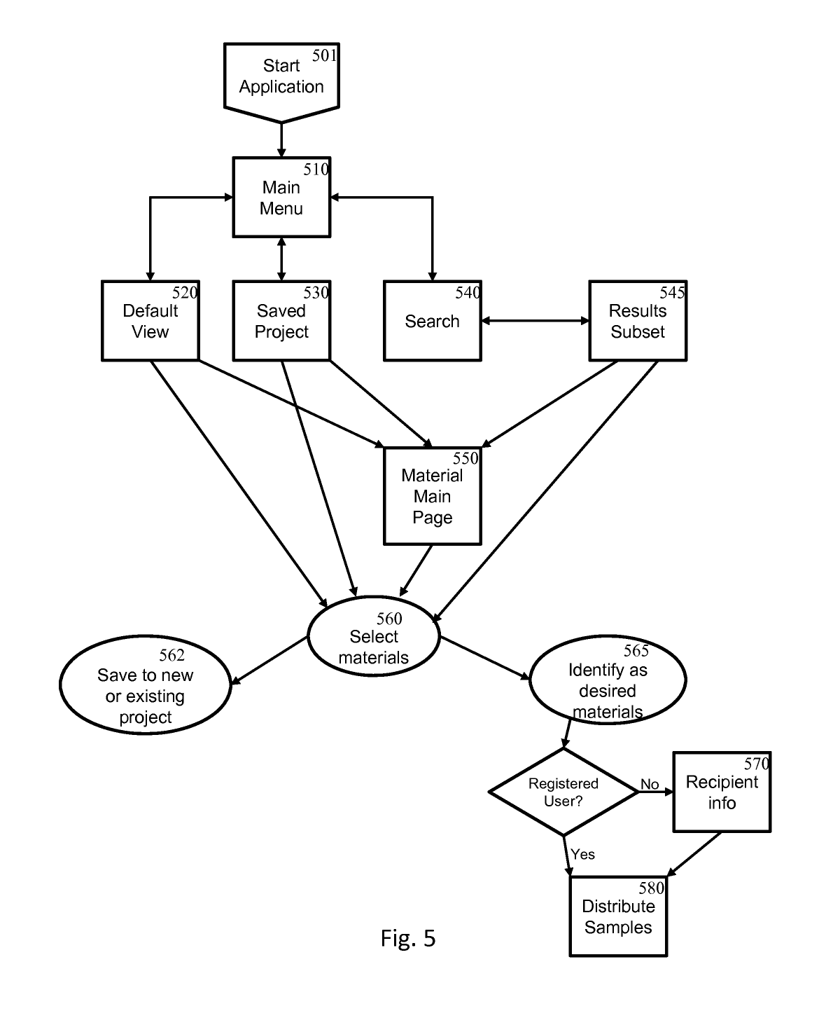

The system 200 can employ a graphical user interface (GUI) to facilitate use. The GUI can be viewed and used on a screen on one of the I/O devices including, without limitation, desktop and portable computers such as notebooks, tablets (e.g., an IPAD®), and on handheld devices such as smart phones (e.g., an IPHONE®). The GUI can include various screens, graphics and text to facilitate various functions. For example as shown in FIG. 5, upon starting the application 501 a main menu screen 510 can be displayed from which a user can request to display a saved project 530, display the plurality of materials in a default view 520, or display a search screen 540 to conduct searches of the database for subsets of materials 545 based on selected search criteria.

From any of the default view 520, project 530, or subset screens 545, a user can select individual materials 560 or select to view additional information on any of the displayed materials. The additional information can include a main page 550 with at least some of the information describing the material. The main page 550 can also link to other pages, electronic documents or processes to execute actions to provide additional information relating to the material.

From any of the default view 520, project 530, subset 545, or main page screens 550, a user can select materials 560. The selected materials can be saved to a new or existing project 562 and/or identified as desired materials 565.

If the user is not a registered user, the user can register using a recipient information screen 570. If a user is a registered user, the user can proceed directly to the sample distribution 580.

The system 200 can also include a processor devoted to use as an inventory database engine 218. The inventory database can include information regarding the inventory of the sample materials. The system 200 can also include a processor devoted to use as a distribution engine 219. The distribution engine 219 can be programmed to initiate a process for distributing at least one sample material from the inventory 250 of sample materials to a recipient, based on the user's selection of materials.

In one embodiment, the system 200 can include at least one data processor 215 coupled to a digital data communications network 310. The data processor 215 can access a data memory configured to maintain a first database 230 and a second database and being programmed to execute instructions. The first database 230 can include information on a plurality of materials and an inventory of sample materials. The information on the plurality of materials can include a description, an image, a plurality of classifying data, and a URL associated for each material. The URL can refer to a web page or other electronic document containing at least a portion of the information on the material. For example, the associated URL can refer to a main page for each material. The material's main page can include the description including a title for the material, an image of the material, and at least a portion of the classifying data for the material. From the main page, a user can also access additional information on the material.

The second database can include information for an electronic publication 240 including text and/or images related to at least one of the plurality of materials. Electronic publications 240 can include, without limitation, web pages, e-books, e-magazines and other digital media. The electronic publication 240 can also include at least one link referring to information in the first database 230 on the at least one material. For example, the electronic publication 240 can include a hyperlink. The data processor 215 can be programmed to execute a process for identifying and displaying the at least one material associated with the hyperlink when the hyperlink is selected. Alternatively, the data processor 215 can be programmed to execute a process for initiating a search process in the first database 230 when the hyperlink is selected.

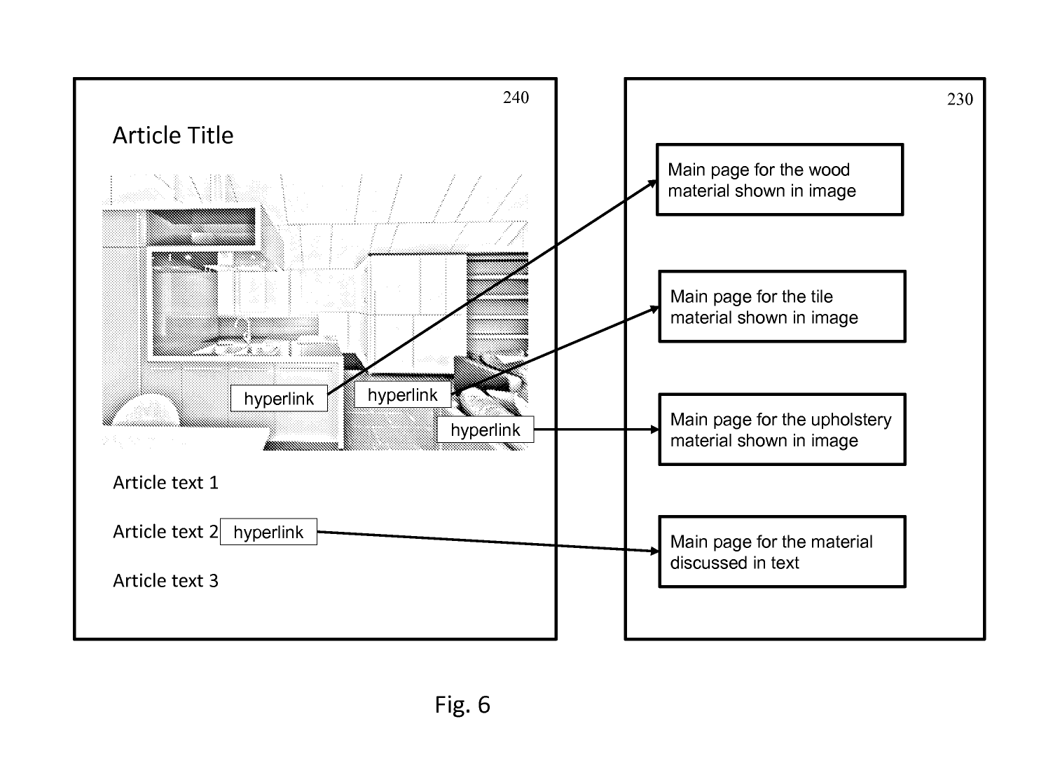

In one arrangement the hyperlink can be for a URL referring to a web page or other electronic document for a material, such as the main page. As shown in FIG. 6, the electronic publication 240 can also include a contextual image showing an application of a material or applications of various materials. A hyperlink can be embedded within the contextual image referring to a page listing information on at least a portion of the materials shown in the image that are also included in the materials database. Separate hyperlinks can also be included for each of the materials and each hyperlink can refer to the main page for each associated material. Each hyperlink can also be embedded in the contextual image in a location corresponding to where the material appears in the contextual image.

Accordingly, a user can access the materials database through a link from an image or text in the electronic publication 240. Once in the materials database, a user can review information on materials, search for additional materials, and select materials to save to a project or as desired materials.

The data processor 215 can also be programmed to execute a process for distributing at least one sample material based on a user's selection of at least one desired material from the plurality of materials.

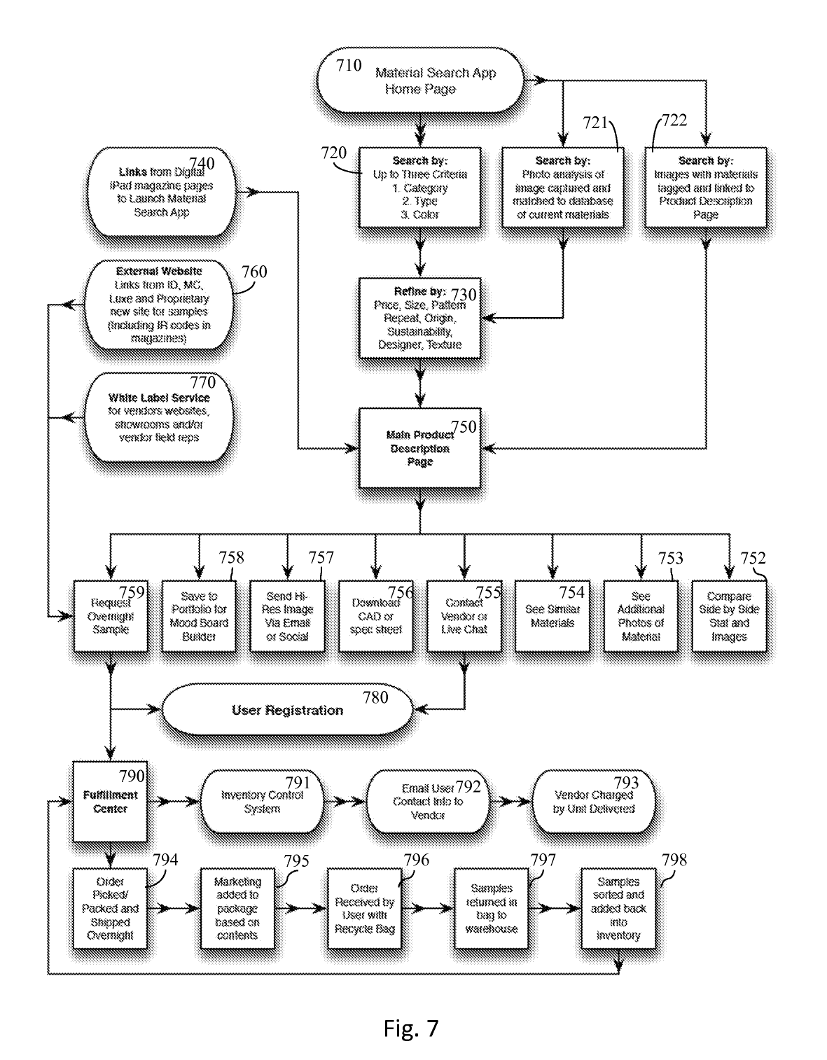

Another arrangement of the system 200 and method 100 is shown in FIG. 7. Users can access the system 200 from the search application home page 710 or from links 740 in digital media referring directly to main pages 750 for the materials shown. From the home page 710, a user can search by selecting classifying data, matching an external image, or viewing contextual images with links. To search by classifying data, a user can initially search by at least one search criteria 720, at least two search criteria, at least three search criteria or at least four search criteria. For example, the user may decide to search by category, type, color, and brand. The initial search results can be refined by searching additional search criteria 730, such as price, size, pattern, origin, sustainability, designer, and texture. Additional information on any of the search results can be viewed on the material's main page 750.

To search by external image 721, the system can conduct a photo analysis of a captured external image and match image characteristics with information in the database of materials. The search results from the photo analysis 721 can be further refined by further searching based on classifying data 730. Additional information on any of the search results can be viewed on the material's main page 750.

A user can also search for materials by viewing contextual images 722. In particular, a user can select a decorative style and/or color for a room as search criteria and the system displays contextual images corresponding to the selections. The displayed contextual images can include links to the main pages 750 for materials shown in a contextual image.

From a materials main page 750, a user may compare materials with a side-by-side display of information 752, view additional images of the material 753, view similar materials 754, contact a supplier 755, download a CAD or specification sheet on the material 756, send an image of the material 757 via e-mail or social media such as Facebook or Twitter, save the material to a project for use in a Mood Board Builder 758, and/or request distribution of a sample of the material 759.

Requests for distribution of samples 759 can also be accessed directly from external website links 760 and specialized services for suppliers 770 linking to the system's distribution functions. For example, suppliers or other third parties can utilize the inventory and distribution services of the system such as in a white label sample distribution service.

When submitting distribution requests, a user can register information 780, including recipient information for the samples. The request and recipient information are provided to a fulfillment center 790. The fulfillment center 790 maintains an inventory control system 791 to update the database regarding sample inventory. After updating the database, the user information is provided to relevant suppliers 792 and suppliers are invoiced for the samples distributed 793.

In connection with an enterprise having a number of points of distribution such as resale or wholesale locations, one or a few fulfillment centers and one or a few sample inventory facilities can serve plural points of distribution according to the methods described herein. The particular inventory made available and the particular terms offered, such as price, shipping, warranties and the like, can be the same across the enterprise or specific to particular distribution points or subsets of distribution points. Likewise, the materials sample system can be provided as a service to manufacturers, retailers, wholesalers or others, who may be unrelated to one another and served, for example, on a private label basis.

The fulfillment center 790 also executes the distribution including picking, packing and shipping an order 794. A shipment can also include marketing materials tailored to the sample materials in the shipment 795. The fulfillment center 790 can also include a return/recycle bag for recipients to return samples 796. Returned samples can be received 797, sorted and added back into the samples inventory 798. The fulfillment center 790 can be operated by the same entity that operated the database or by a separate entity.

The present disclosure can be embodied in the form of methods and apparatus for practicing those methods. The system can also be embodied in the form of program code embodied in tangible media, such as floppy diskettes, CD-ROMs, DVD-ROMs, blu-ray disks, hard drives, or any other machine-readable storage medium, wherein, when the program code is loaded into and executed by a machine, such as a computer, the machine becomes an apparatus for practicing the invention. The system can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

The foregoing is provided for purposes of illustrating, explaining, an describing embodiments of the system and method. Modifications and adaptations to these embodiments will be apparent to those skilled in the art and may be made without departing from the scope or spirit of this disclosure.

1. A method for identification and distribution of material samples, comprising the steps of:
maintaining a computerized database containing information defining a plurality of materials available for one of distribution and sale, and maintaining an associated inventory of sample materials representing at least some of the plurality of materials, the information defining the plurality of materials comprising a description, an image, and a plurality of classifying data providing information associated with each material;
identifying a subset of the plurality of materials based on selected search criteria provided by a user;
displaying at least part of the information associated with the subset of the plurality of materials;
receiving a selection of desired materials from the subset;
queuing from the database and executing a distribution order by which the sample materials corresponding to at least part of the selection of the desired materials are provided to a recipient;
updating the database to reflect execution of the distribution order and passing out from the inventory of the sample materials provided to the recipient.

2. The method according to claim 1, wherein the plurality of materials comprise materials selected from the group consisting of natural and synthetic textiles, glass, stone materials, ceramic materials, metals, laminates, lumber, paint, other coatings and combinations thereof.

3. The method according to claim 1, wherein the selected search criteria comprises a material identifier associated with a subset comprising at least one material and the step of identifying the subset further comprises receiving the material identifier, searching the database using the material identifier as at least one search criterion, and associating the material identifier with the subset based on at least partial matching of the material identifier with the subset.

4. The method according to claim 3, wherein the material identifier comprises a uniform resource locator; and displaying the subset further comprises providing a web page link associated with the uniform resource locator and including the subset of materials.

5. The method according to claim 1, wherein the database and the selected search criteria contain classifying data and the step of identifying the subset of the plurality of materials further comprises:
searching the database to identify a primary subset of the plurality of materials based on a primary subset of the classifying data; and
searching the primary subset to identify a secondary subset of the plurality of materials based on a secondary subset of the classifying data.

6. The method according to claim 1, wherein the plurality of classifying data comprises at least one of: application for material, type of material, color, color family, brand, price range, size, pattern, origin, sustainability, designer, and texture information for each material.

7. The method according to claim 1, wherein the selected search criteria comprises an external image and the step of identifying the subset of the plurality of materials further comprises:
receiving the external image;
identifying image characteristics associated with the external image; and
searching the database to identify a subset of the plurality of materials associated with at least part of the image characteristics of the external image.

8. The method according to claim 1, wherein the selected search criteria comprises input text and the step of identifying the subset of the plurality of materials further comprises:
receiving the input text; and
searching the database to identify a subset of the plurality of materials with descriptions corresponding to at least part of the input text.

9. The method according to claim 1, the step of executing the distribution order for the sample materials further comprising:
receiving recipient shipping information; and
generating shipping indicia for delivery of the samples according to predetermined terms.

10. The method according to claim 1, further comprising retrieving at least one sample back into the inventory of sample materials and updating the database to reflect the retrieval of the sample materials.

11. The method according to claim 1, further comprising associating in the database a substantially unique identifier (UID) with the sample materials and further comprising tracking the inventory of sample materials via the UID.

12. The method according to claim 11, wherein the UID is associated with a supplier's serial number for the sample material.

13. The method according to claim 1, further comprising associating each of the plurality of materials with a supplier and invoicing a supplier based on the number of sample materials supplied by the supplier that are distributed to recipients.

14. The method according to claim 1, wherein the step of managing the database further comprises accessing at least one supplier database storing information on at least one of the plurality of materials and retrieving information on at least one of the description, the image, or classifying data for the at least one material.

15. A system for identification and distribution of materials, comprising:
at least one data processor having access to a data memory configured to maintain a database and being programmed to execute instructions;
wherein the database contains information describing a plurality of materials and an inventory of sample materials representing at least some of the plurality of materials, the information on the plurality of materials comprising a description, an image, and a plurality of classifying data associated for each material;
wherein the data processor is further programmed to execute a process for searching the database and displaying a subset of the plurality of materials based on selected search criteria provided by a user; and
wherein the data processor is further programmed to initiate a process for distributing at least one sample material from the inventory of sample materials to a recipient, based on the user's selection of at least one desired material from the plurality of materials.

16. The system according to claim 15, wherein the database associates a substantially unique identifier (UID) with each of the sample materials and the data processor is further programmed to execute a process for tracking the inventory of sample materials via the UID.

17. The system according to claim 15, wherein the data processor is further programmed to execute a process for associating a subset the plurality of materials selected by a user with a project identifier and displaying the subset associated with the project identifier.

18. The system according to claim 15, wherein the information contained in the database further comprises contextual images associated with each material.

19. A system for identification and distribution of materials, comprising:
at least one data processor coupled to a digital data communications network, the data processor having access to a data memory configured to maintain a first database and a second database and being programmed to execute instructions;
wherein the first database stores information on a plurality of materials and an inventory of sample materials for each of the plurality of materials, the information comprising a description, an image, a plurality of classifying data, and a uniform resource locator (URL) associated for each material;
wherein the second database stores information for an electronic publication comprising a contextual image and a materials hyperlink, wherein the contextual image displays at least one of the plurality of materials and the materials hyperlink is directed to the information in the first database on the at least one material in the contextual image;
wherein the data processor is programmed to execute a process for identifying and displaying the at least one material associated with the materials hyperlink when the materials hyperlink is selected; and
wherein the data processor is further programmed to execute a process for automatically distributing at least one sample material based on a user's selection of at least one desired material from the plurality of materials.

20. The system according to claim 19, wherein the data processor is further programmed to execute a process for searching the first database and displaying a subset of the plurality of materials based on selected search criteria; and
the second database further stores information for the electronic publication comprising a search hyperlink, wherein the search hyperlink is directed to the process for searching the first database.
